(19) United States
(12) Patent Application Publication
(10) Pub. No.: US 2023/0296920 A1
(43) Pub. Date: Sep. 21, 2023

(54) LIGHT CONTROLLED ADJUSTABLE LENS

(71) Applicant: Toyota Motor Engineering & Manufacturing North America, Inc., Plano, TX (US)

(72) Inventors: Shailesh N. Joshi, Ann Arbor, MI (US); Ercan M. Dede, Ann Arbor, MI (US)

(73) Assignee: Toyota Motor Engineering & Manufacturing North America, Inc., Plano, TX (US)

(21) Appl. No.: 17/694,854

(22) Filed: Mar. 15, 2022

(51) Int. Cl. G02C 7/06; G02C 7/02

(52) U.S. Cl. CPC G02C 7/061; G02C 7/022

(57) ABSTRACT

Apparatuses, systems, and methods relate to technology to identify that a focal length of an adjustable lens is to be modified, where the adjustable lens is supported by a frame. The technology controls a light source to emit light towards the adjustable lens, wherein the light source is supported by the frame and adjusts a curvature of the adjustable lens with the light to modify the focal length of the adjustable lens.

### TECHNICAL FIELD

Embodiments generally relate to an adjustable lens that may have an adjustable focal length. In particular, the focal length is adjusted with a light-based system.

### BACKGROUND

A lens may be a transparent substance that is curved to disperse or concentrate light. In many cases, the lens may have a static curvature(s) meaning that the curvature(s) are set and cannot be changed. Doing so may limit the potential uses of the lens. For example, the lens may have a focal length that corresponds to the curvature(s) of the lens. Focal length may be the distance between the center of the lens and the point at which objects are brought into clear focus. The focal length therefore cannot be changed since the curvature(s) are static, such that the user is limited to viewing objects at/nearby the focal length in clear focus, while other objects may be blurry and unfocused.

### BRIEF SUMMARY

In some embodiments, an eyeglass system comprises a frame, an adjustable lens supported by the frame, a light source supported by the frame and that is configured to emit light, a processor. The eyeglass system further includes a memory having a set of instructions, which when executed by the processor, cause the eyeglass system to identify that a focal length of the adjustable lens is to be modified, control the light source to emit the light from the light source towards the adjustable lens, and adjust a curvature of the adjustable lens with the light to modify the focal length of the adjustable lens.

In some embodiments, at least one non-transitory computer readable storage medium comprises a set of instructions, which when executed by an eyeglass system, cause the eyeglass system to identify that a focal length of an adjustable lens is to be modified, wherein the adjustable lens is supported by a frame, control a light source to emit light towards the adjustable lens, wherein the light source is supported by the frame, and adjust a curvature of the adjustable lens with the light to modify the focal length of the adjustable lens.

In some embodiments, a method is provided that controls an eyeglass system. The method comprises identifying that a focal length of an adjustable lens is to be modified, wherein the adjustable lens is supported by a frame, controlling a light source to emit light towards the adjustable lens, wherein the light source is supported by the frame, and adjusting a curvature of the adjustable lens with the light to modify the focal length of the adjustable lens.

### BRIEF DESCRIPTION OF THE SEVERAL VIEWS OF THE DRAWINGS

The various advantages of the embodiments of the present disclosure will become apparent to one skilled in the art by reading the following specification and appended claims, and by referencing the following drawings, in which:

FIG. 1 is a diagram of an example of a light-based lens adjustment process and structure according to an embodiment;

FIG. 2 is a diagram of an example of an eyeglass system with an extended frame according to an embodiment;

FIG. 3 is a diagram of an example of an eyeglass system that has an embedded light source according to an embodiment;

FIG. 4 is a flowchart of an example of a method of adjusting a focal length of a lens according to an embodiment;

FIG. 5 is a flowchart of an example of a method of adjusting a focal length of a lens with light intensity adjustments according to an embodiment;

FIG. 6 is a flowchart of an example of a method of adjusting a focal length of a lens with light wavelength adjustments according to an embodiment;

FIG. 7 is a flowchart of an example of a method of automatically adjusting a focal length of a lens to view an object according to an embodiment;

FIG. 8 is a diagram of an example of an eyeglass system with two lenses according to an embodiment; and

FIG. 9 is a block diagram of an example of a control system to adjust a focal length of an eyeglass system according to an embodiment.

### DETAILED DESCRIPTION

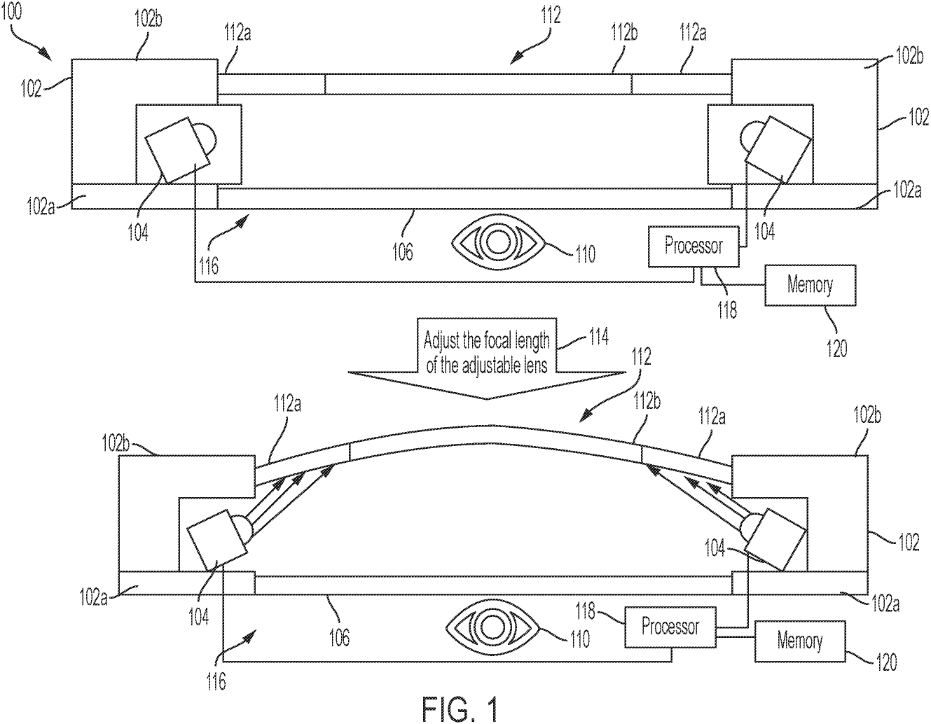

Turning now to FIG. 1, a lens adjustment process 100 is illustrated. As will be explained in further detail below, the lens adjustment process 100 generates light to adjust a focal length of an eyeglass system 116. That is, the lens adjustment process 100 transmits light to adjust a curvature of an adjustable lens 112 of the eyeglass system 116. A focal length of the adjustable lens 112 may be modified based on the adjustment to the curvature. For example, as the curvature is increased, the focal length may correspondingly decrease. Thus, the focal length of the adjustable lens 112 is modified based on the light. Adjusting the focal length of the adjustable lens 112 based on light enables on the fly focusing adjustments to the adjustable lens 112 with reduced latency, reduced power and reduced form factor relative to the conventional designs that may utilize voltage and/or current to adjust a lens.

As illustrated in FIG. 1, the eyeglass system 116 includes a frame 102 coupled to the adjustable lens 112. The eyeglass system 116 further includes a light source 104 supported by the frame 102 and that is configured to emit the light. The eyeglass system 116 further includes a processor 118. The eyeglass system 116 further includes a memory 120 having a set of instructions, which when executed by the processor 118, cause the eyeglass system 116 to identify that a focal length of the adjustable lens 112 is to be modified, control the light source 104 to emit light from the light source 104 towards the adjustable lens 112, and adjust a curvature of the adjustable lens 112 with the light to modify the focal length of the adjustable lens 112. For example, the eyeglass system determines a requested change in the focal length of the adjustable lens 112, determines an intensity of the light based on the requested change, and emit the light at the intensity to adjust the curvature of the adjustable lens 112. In some examples, the eyeglass system 116 may include at least one non-transitory computer readable storage medium comprising a set of instructions, which when executed by an eyeglass system, cause the eyeglass system to execute the above.

The user may be wearing the eyeglass system 116. That is, the user may wear the eyeglass system 116 over the eye 110 to adjust a vision of the eye 110. As illustrated, the eyeglass system 116 further comprises a back lens 106 supported by the frame 102 to prevent and/or reduce eye damage to the user. The back lens 106 includes a material to block the light from the light source 104 from passing through the back lens 106. The back lens 106 is disposed between the adjustable lens and the eye 110 of the user so as to block the light of the light source 104, that is reflected by the adjustable lens 112, from reaching the eye 110. Doing so may reduce and/or prevent the light from unintentionally reaching the eye 110. For example, the light source 104 may be may an ultra-violet light source and/or laser. Thus, it may be desirable to block and/or reduce the light from the light source 104 from reaching the eye 110.

Furthermore, the frame 102 includes a first light blocking wall 102a to block the light from the light source 104 from being transmitted to the user. The first light blocking wall partially houses the light source. The first light blocking wall 102a is disposed between the user and the light source 104 to block the light from the user. Furthermore, the frame 102 includes a second light blocking wall 102b to block light from reaching outside the eyeglass system.

As illustrated, the adjustable lens 112 is initially in a straightened position. That is, the adjustable lens 112 has a minimal curvature. The user may determine that the user desires to view an object at a distance away from the user in increased clarity. To do so, the user may indicate that the focal length of the adjustable lens 112 should be adjusted to match the distance (e.g., the focal length is set to the distance). For example, the user may provide an instruction (e.g., via a mobile device) to the eyeglass system 116 to adjust the focal length. For example, the user may have a mobile device that the user utilizes to transmit (e.g., via a Bluetooth connection, a wired and/or wireless connection) the message to the eyeglass system.

In turn, the lens adjustment process 100 may adjust the focal length of the adjustable lens 112, 114. As illustrated, a curvature of the adjustable lens 112 may be adjusted based on the light emitted from the light source 104. The light may interact with a material of the adjustable lens 112 that causes the adjustable lens 112 to deform and establish a curvature to achieve the change in focal length. For example, the adjustable lens 112 may include a spiropyran material that interacts with the light. Spiropyran is an organic compound that has certain photochromic properties. For example, when exposed to certain lights (e.g., ultraviolet (UV) light, laser light, etc.), spiropyran expands, causing the material in which the spiropyran is infused to also expand. Thus the adjustable lens 112 may be a flexible lens material (e.g., any type of flexible material such as plastics, including Poly(methyl acrylate), Poly(methyl methacrylate), low-density polyethylene, etc.). During the production of the adjustable lens 112, spiropyran is mixed into the flexible lens material. In some embodiments, spiropyran may be deposited on a surface of the adjustable lens 112, such as on the bottom surface that is closest to the light source 104, rather than be distributed in the interior of the adjustable lens 112.

In some embodiments, only the outer peripheral portions 112a of the adjustable lens 112 are coated with and/or include spiropyran while the interior portions are not coated with and/or do not include spiropyran. That is, the light from the light source 104 may be directed towards the outer peripheral portions 112a of the adjustable lens 112 and as such, the outer peripheral portions 112a may be include spiropyran which interacts with the light. A central portion 112b between the outer peripheral portions 112a may not receive the light, and therefore spiropyran is not included in the central portion 112b for efficiency. Thus, the adjustable lens 112 may include spiropyran in only the outer peripheral portions 112a. In other embodiments, spiropyran may be distributed throughout the entire adjustable lens 112

When light is projected towards the adjustable lens 112, the spiropyran within the adjustable lens 112 causes the adjustable lens 112 to curve. The change in curvature of the adjustable lens 112 changes the focal length of the adjustable lens 112. The amount that the adjustable lens 112 bends may be adjusted based on the characteristics (e.g., intensity, wavelength, etc.) of the light emitted by the light sources 104. As such, the eyeglass system 110 has variable focal lengths based on the characteristics of the light.

The characteristics (e.g., intensity) of the light emitted by the light sources 104 may be controlled by the processor 118. The processor 118 may be connected to an input device. The input device may be a touch sensor and/or accelerometer incorporated within the frame 102 that may indicate when a user is touching or tapping the frame 102. Upon touching or tapping the frame 102, the processor 118 may adjust the intensity of the UV light emitted by the light sources 104 to adjust the focal length of the adjustable lens 112 (e.g., increase the intensity or reset the intensity to a baseline level if enough taps are identified). In some embodiments, the input device may be a Bluetooth capable device, such as a mobile phone, which may have an application that allows a user to indicate what type of focal length they would like the eyeglass system 116 to utilize. Upon receiving this information from the mobile device via Bluetooth, the processor 118 will then output the appropriate light towards the adjustable lens 112. For example, a user may indicate that the focal length should be three feet from the eyeglass system 116. In turn, the eyeglass system 116 may control the light emitted from the light sources 104 so that the focal length of the eyeglass system 116 is three feet from the eyeglass system 116.

In some embodiments, the light sources 104 are light emitting diodes (LEDs) that are configured to selectively project UV light towards the adjustable lens 112. The light sources 104 are located within cavities of the frame 102. In the example shown in FIG. 1, the light sources 104 are embedded within a cavity defined by first and second light blocking walls 102a, 102b of the frame 102. The frame 102 may contain additional shielding to direct UV light emitted by the light sources 104 towards the adjustable lens 112 and not towards the back lens 106 and potentially the eye 110. The additional shielding may be formed of a light blocking material or a light blocking coat such as black color.

After the focal length is adjusted as illustrated at the bottom of the page, the processor 118 may control the light source 104 to emit the light. The back lens 106 does not alter in shape, and may not include the flexible lens material and/or the spiropyran. The back lens 106 may be omitted in some embodiments. The back lens 106 be a visible light transparent glass, polymer, etc. Furthermore, in some embodiments the light sources 104 may be self-contained at least to the extent that the light sources 104 do not require external power sources. Furthermore, the processor 118 and the memory 120 may be disposed within the frame 102 in some embodiments.

In some embodiments, the light source 104 may pivot so as to direct the light towards different portions of the adjustable lens 112 based on the adjustment to the focal length. For example, some embodiments may include the light source 104 directing the light towards areas with high spiropyran amounts when a large curvature is desired, and areas with lower spiropyran amounts when a small curvature is desired.

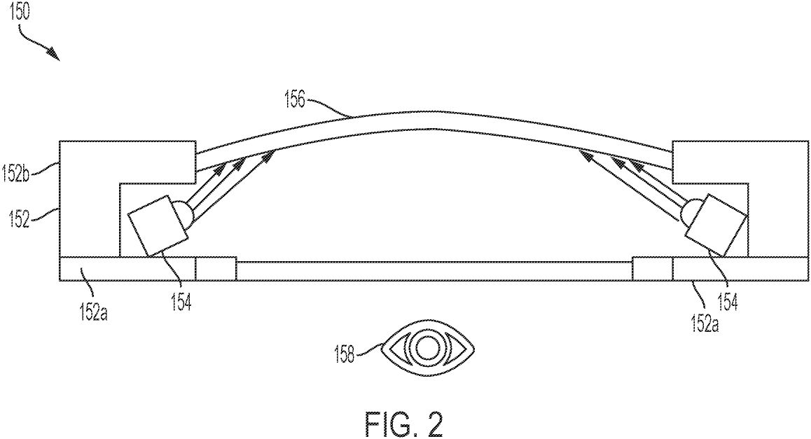

FIG. 2 illustrates an eyeglass system 150 with an extended frame 152. Elements similar to those discussed with reference to FIG. 1 are omitted herein for brevity. The extended frame 152 includes a first light blocking wall 152a and a second light blocking wall 152b. The first light blocking wall 152a has a greater length than the second light blocking wall 152b so as to protrude farther towards an interior of the eyeglass system 150 than the second light blocking wall 152b.

A light source 154 may emit light towards an adjustable lens 156 to adjust a curvature of the adjustable lens 156. The first light blocking wall 152a may have a greater length to reduce reflected light from reaching an eye 158 of a user. Furthermore, the second light blocking wall 152b may have a smaller length than the first light blocking wall 152a to avoid occluding the light source 154 and enable the light source 154 to transmit the light to the adjustable lens 156.

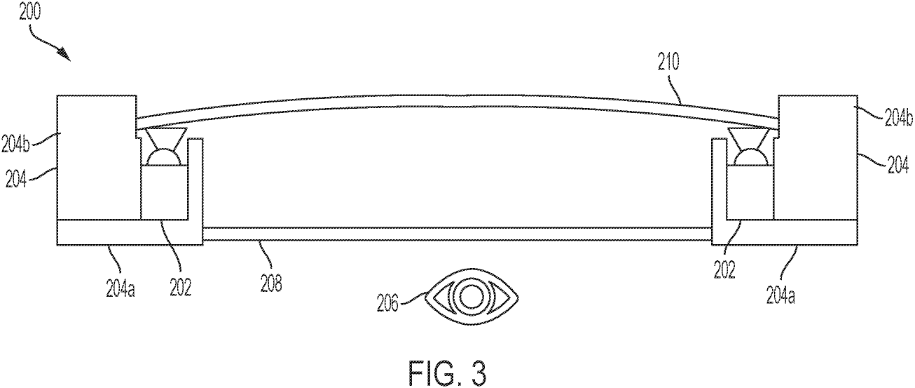

Turning now to FIG. 3, an eyeglass system 200 that has an embedded light source 202 is illustrated. Elements similar to those discussed with reference to FIG. 1 are omitted herein for brevity. In this example, the light source 202 is embedded in a frame 204. In this example, a first light blocking wall 204a extends beyond an emission point of the light source 202 in a direction towards a flexible lens. Notably, the first light blocking wall 204a is disposed between the back lens 208 and the light source 202 to block emissions from reaching the back lens 208 and the eye 206. A second light blocking wall 204b extends along the light source 202 as well.

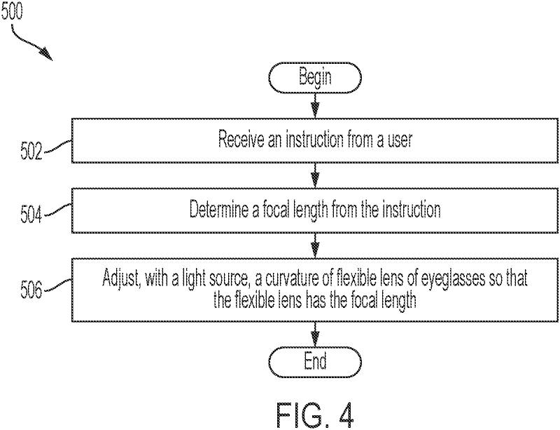

FIG. 4 shows a method 500 of adjusting a focal length of a lens. The method 500 may generally be implemented in conjunction with any of the embodiments described herein, for example the lens adjustment process 100 (FIG. 1), the eyeglass system 150 (FIG. 2) and/or eyeglass system 200 (FIG. 3). In an embodiment, the method 500 is implemented in logic instructions (e.g., software), configurable logic, fixed-functionality hardware logic, non-transitory computer readable instructions that are executable to implement method 500, circuitry, etc., or any combination thereof.

Illustrated processing block 502 receives an instruction from a user. The instruction may be received via a sensor (e.g., a touch sensor, auditory sensor, etc.). Illustrated processing block 504 determines a focal length from the instruction. For example, the instruction may indicate that the focal length is to change by some amount (e.g., 2 feet farther) or a distance (e.g., 20 feet away from the eyeglasses). Illustrated processing block 506 adjusts, with a light source, a curvature of a flexible lens of eyeglasses so that the flexible lens has the focal length.

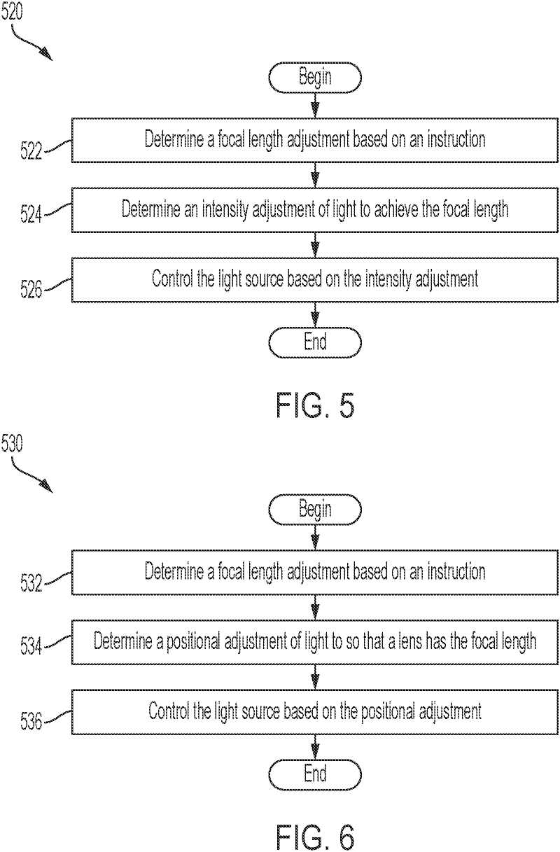

FIG. 5 shows a method 500 of adjusting a focal length of a lens. The method 500 may generally be implemented in conjunction with any of the embodiments described herein, for example the lens adjustment process 100 (FIG. 1), the eyeglass system 150 (FIG. 2) and/or eyeglass system 200 (FIG. 3) and/or method 500 (FIG. 4). In an embodiment, the method 520 is implemented in logic instructions (e.g., software), configurable logic, fixed-functionality hardware logic, non-transitory computer readable instructions that are executable to implement method 520, circuitry, etc., or any combination thereof.

Illustrated processing block 522 determines a focal length adjustment based on an instruction. Illustrated processing block 524 determines an intensity adjustment of light to so that a curvature of a lens is adjusted to match the focal length adjustment. Illustrated processing block 526 controls the light source based on the intensity adjustment so that the light source emits light at the intensity. Doing so adjusts the focal length of a lens through an adjustment of the intensity.

FIG. 6 shows a method 530 of adjusting a focal length of a lens. The method 530 may generally be implemented in conjunction with any of the embodiments described herein, for example the lens adjustment process 100 (FIG. 1), the eyeglass system 150 (FIG. 2) and/or eyeglass system 200 (FIG. 3), method 500 (FIG. 4) and/or method 520 (FIG. 5). In an embodiment, the method 530 is implemented in logic instructions (e.g., software), configurable logic, fixed-functionality hardware logic, non-transitory computer readable instructions that are executable to implement method 530, circuitry, etc., or any combination thereof.

Illustrated processing block 532 determine a focal length adjustment based on an instruction. Illustrated processing block 534 determines a positional adjustment of light to so that a lens has the focal length (e.g., change where the light is focused). Illustrated processing block 536 controls the light source (e.g., ultra-violet, blue, red, green, etc.). based on the positional adjustment so that the light source emits light at a specific position. Doing so adjusts the focal length of a lens through an adjustment of the wavelength.

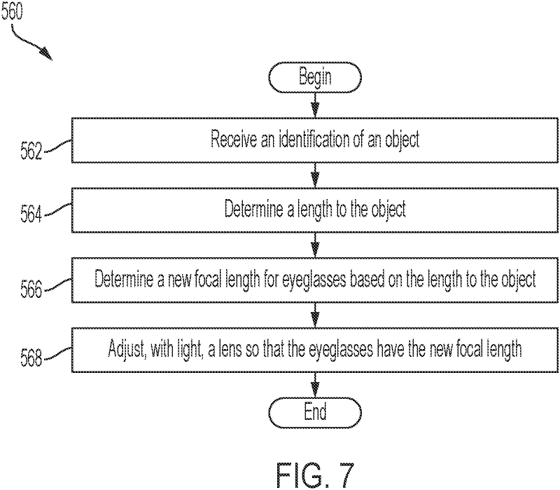

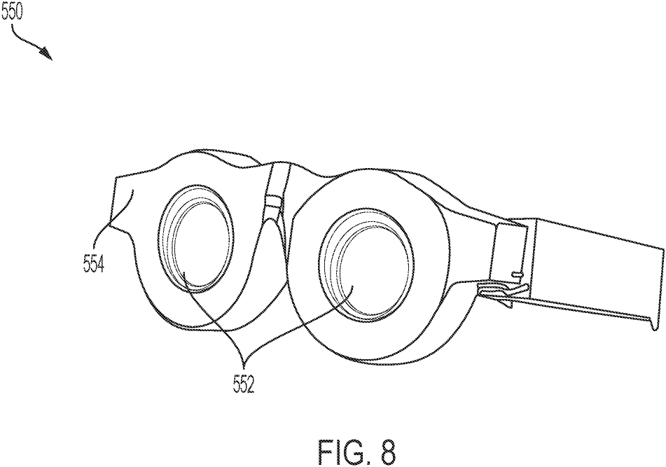

FIG. 7 shows a method 560 of automatically adjusting a focal length of a lens. The method 560 may generally be implemented in conjunction with any of the embodiments described herein, for example the lens adjustment process 100 (FIG. 1), the eyeglass system 150 (FIG. 2) and/or eyeglass system 200 (FIG. 3), method 500 (FIG. 4) and/or method 530 (FIG. 6). In an embodiment, the method 520 is implemented in logic instructions (e.g., software), configurable logic, fixed-functionality hardware logic, non-transitory computer readable instructions that are executable to implement method 520, circuitry, etc., or any combination thereof.

Illustrated processing block 562 receives an identification of an object. For example, a user may select the object via an auditory signal, visual signal, etc. Illustrated processing block 564 determines a length to the object. For example, processing block 564 may access sensors to generate an image of the object, and determine how far away the object is from the eyeglasses based on the image. Illustrated processing block 566 determines a new focal length for eyeglasses based on the length to the object. For example, illustrated processing block 566 may set the focal length to equal the distance. Illustrated processing block 568 adjusts, with light, a lens so that the eyeglasses have the new focal length.

FIG. 8 shows an eyeglass system 550 according to embodiments herein. The eyeglass system 550 may generally be implemented in conjunction with any of the embodiments described herein, for example the lens adjustment process 100 (FIG. 1), the eyeglass system 150 (FIG. 2) and/or eyeglass system 200 (FIG. 3), method 500 (FIG. 4), method 530 (FIG. 6) and/or method 560 (FIG. 7). The eyeglass system 550 includes a frame 554 that supports two adjustable lenses 552. The frame 554 may include light sources that adjust curvatures of the two adjustable lenses 552. In this example, there may be two light sources (in a one-to-one correspondence with the adjustable lenses) or four (in a two-to-one correspondence with the adjustable lenses). Thus a user may provide an instruction to the eyeglass system 550 to adjust a focal length of the eyeglass system 550.

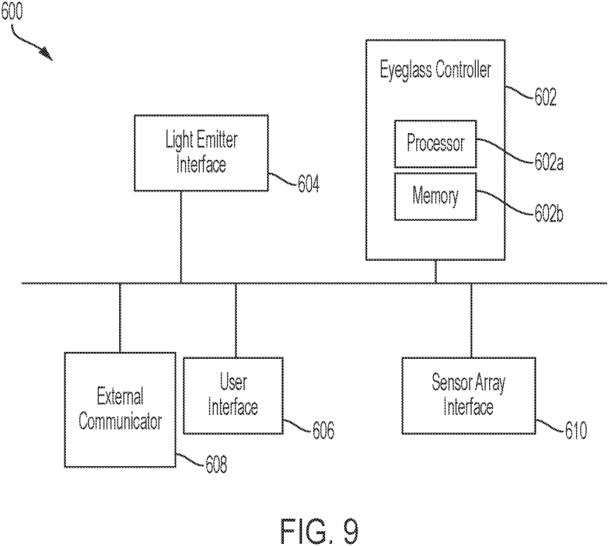

FIG. 9 shows a more detailed example of a control system 600 to adjust a focal length of an eyeglass system that includes the control system 600. The illustrated control system 600 may be readily included in for example the lens adjustment process 100 (FIG. 1), the eyeglass system 150 (FIG. 2) and/or eyeglass system 200 (FIG. 3), method 500 (FIG. 4), method 520 (FIG. 5), method 530 (FIG. 6) and/or method 560 (FIG. 7).

In the illustrated example, the control system 600 may include an external communicator 608 that may communicate with external devices (e.g., mobile devices, computers, etc.) to receive instructions. The control system 600 may include a sensor array interface 610 that interfaces with a plurality of sensors, for example a global positioning system sensor, proximity sensor, image sensor, audio sensor, etc. to receive indications of the environment and adjust a focal length accordingly. The sensor array interface 610 may interface with any type of sensor suitable for operations as described herein.

The control system 600 also includes a user interface 606 (e.g., audio and/or visual interface) to receive instructions from the user. The instructions may indicate an adjustment to a focal length of the eyeglass system. For example, a light emitter interface 604 may communicate with a light emitter to emit light to an adjustable lens to adjust the curvature of the adjustable lens, and correspondingly adjust the focal length of the eyeglass system.

An eyeglass controller 602 may receive the instruction and adjust the focal length through the light emitter interface 604. The eyeglass controller 602 includes a processor 602a (e.g., embedded controller, central processing unit/CPU) and a memory 602b (e.g., non-volatile memory/NVM and/or volatile memory) containing a set of instructions, which when executed by the processor 602a, cause the light emitter interface 604 to control the light emitter to generate light that adjusts the focal length of the eyeglass system.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present disclosure can be implemented in a variety of forms. Therefore, while the embodiments of this disclosure have been described in connection with particular examples thereof, the true scope of the embodiments of the disclosure should not be so limited since other modifications will become apparent to the skilled practitioner upon a study of the drawings, specification, and following claims.

We claim:

1. An eyeglass system, comprising:
a frame;
an adjustable lens supported by the frame;
a light source supported by the frame and that is configured to emit light;
a processor; and
a memory having a set of instructions, which when executed by the processor, cause the eyeglass system to:
identify that a focal length of the adjustable lens is to be modified;
control the light source to emit the light from the light source towards the adjustable lens; and
adjust a curvature of the adjustable lens with the light to modify the focal length of the adjustable lens.

2. The eyeglass system of claim 1, wherein the instructions of the memory, when executed, cause the eyeglass system to:
determine a requested change in the focal length of the adjustable lens;
determine an intensity of the light based on the requested change; and
emit the light at the intensity to adjust the curvature of the adjustable lens.

3. The eyeglass system of claim 1, further comprising a back lens supported by the frame and that includes a material to block the light from passing through the back lens, wherein the back lens is disposed between the adjustable lens and a user.

4. The eyeglass system of claim 1, wherein the light source is an ultra-violet light source.

5. The eyeglass system of claim 1, wherein the frame includes a light blocking wall to block the light emitted by the light source, wherein the light blocking wall partially houses the light source.

6. The eyeglass system of claim 5, wherein the light blocking wall is disposed between a user and the light source to block the light from the user.

7. The eyeglass system of claim 1, wherein the adjustable lens includes a spiropyran material.

8. At least one non-transitory computer readable storage medium comprising a set of instructions, which when executed by an eyeglass system, cause the eyeglass system to:
identify that a focal length of an adjustable lens is to be modified, wherein the adjustable lens is supported by a frame;
control a light source to emit light towards the adjustable lens, wherein the light source is supported by the frame; and
adjust a curvature of the adjustable lens with the light to modify the focal length of the adjustable lens.

9. The at least one non-transitory computer readable storage medium of claim 8, wherein the instructions, when executed, cause the eyeglass system to:
determine a requested change in the focal length of the adjustable lens;
determine an intensity of the light based on the requested change; and
emit the light at the intensity to adjust the curvature of the adjustable lens.

10. The at least one non-transitory computer readable storage medium of claim 8, wherein a back lens is supported by the frame, wherein the back lens includes a material to block the light from passing through the back lens, wherein the back lens is disposed between the adjustable lens and a user.

11. The at least one non-transitory computer readable storage medium of claim 8, wherein the light source is an ultra-violet light source.

12. The at least one non-transitory computer readable storage medium of claim 8, wherein the frame includes a light blocking wall to block the light emitted by the light source, wherein the light blocking wall partially houses the light source.

13. The at least one non-transitory computer readable storage medium of claim 12, wherein the light blocking wall is disposed between a user and the light source to block the light from the user.

14. The at least one non-transitory computer readable storage medium of claim 8, wherein the adjustable lens includes a spiropyran material.

15. A method of controlling an eyeglass system, the method comprising:
identifying that a focal length of an adjustable lens is to be modified, wherein the adjustable lens is supported by a frame;
controlling a light source to emit light towards the adjustable lens, wherein the light source is supported by the frame; and
adjusting a curvature of the adjustable lens with the light to modify the focal length of the adjustable lens.

16. The method of claim 15, further comprising:
determining a requested change in the focal length of the adjustable lens;
determining an intensity of the light based on the requested change; and
emitting the light at the intensity to adjust the curvature of the adjustable lens.

17. The method of claim 15, wherein a back lens is supported by the frame, wherein the back lens includes a material to block the light from passing through the back lens, wherein the back lens is disposed between the adjustable lens and a user.

18. The method of claim 15, wherein the light source is an ultra-violet light source.

19. The method of claim 15, wherein the frame includes a light blocking wall to block the light emitted by the light source, wherein the light blocking wall partially houses the light source.

20. The method of claim 19, wherein the light blocking wall is disposed between a user and the light source to block the light from the user, further wherein the adjustable lens includes a spiropyran material.
